(19) United States
(12) Patent Application Publication
(10) Pub. No.: US 2002/0069124 A1
(43) Pub. Date: Jun. 6, 2002

(54) Agricultural product business system

(76) Inventors: Alice Hayes, West Linn, OR (US); Mark Hayes, West Linn, OR (US); Rolf Kraus, Beaverton, OR (US); David Specht, Beaverton, OR (US)

Correspondence Address: George M. Macdonald, Greenberg Traurig, LLP, 885 Third Avenue, New York, NY, 10022, US

(21) Appl. No.: 09/845,572

(22) Filed: Apr. 30, 2001

Related U.S. Application Data
(60) Provisional application No. 60/200,862, filed on May 1, 2000.

(51) Int. Cl. G06F 17/60

(52) U.S. Cl. 705/26

(57) ABSTRACT

A method and apparatus for distributing agricultural products by selectively distributing orders among a network of agricultural product suppliers is described.

### CROSS REFERENCE TO RELATED APPLICATIONS

This application claims priority under 35 U.S.C. § 119(e) of U.S. Provisional Patent Application Serial No. 60/200,862, filed May 1, 2000 and incorporated herein by reference.

### FIELD OF THE INVENTION

The present invention relates generally to a method and apparatus for distributing agricultural products by selectively distributing orders among a network of agricultural product suppliers.

### BACKGROUND

Conventional agricultural product distributions systems result in delivery delay measured from the time of harvest

### BRIEF SUMMARY OF THE INVENTION

A method and system for distributing agricultural products is described. The method and system are utilized to selectively distribute orders among a network of agricultural product suppliers.

### BRIEF DESCRIPTION OF THE DRAWINGS

FIG. 1 is an illustrative representation of a display showing a consumer web page interface according to an embodiment of the present application;

FIG. 2 is an illustrative representation of a display showing a selected agricultural product web page consumer interface according to an embodiment of the present application;

FIG. 3 is an illustrative representation of a display showing a selected agricultural product subscription web page consumer interface according to an embodiment of the present application;

FIG. 4 is an illustrative representation of a display showing a recipient data web page consumer interface according to an embodiment of the present application;

FIGS. 5A-C are illustrative representations of a displays showing recipient data web page consumer interfaces according to an embodiment of the present application;

FIG. 6 is an illustrative representation of a display showing a interactive order suggestion web page consumer interface according to an embodiment of the present application;

FIG. 7 is an illustrative representation of a display showing a interactive order suggestion web page consumer interface providing determined suggestions according to an embodiment of the present application; and

FIG. 8 is an illustrative representation of a display showing a billing information web page consumer interface according to an embodiment of the present application.

### DETAILED DESCRIPTION OF THE PREFERRED EMBODIMENTS

In a preferred embodiment, the method and system of the present invention is implemented as a computer-implemented system and method for receiving orders for agricultural products and selectively distributing those orders to a network of agricultural product suppliers such as growers. Growers may be distributors or may supply distributors that ship agricultural products.

The system may be implemented in a variety of ways within the scope of the invention. In an exemplary embodiment described below, at least a portion of the system is implemented as an automated electronic-commerce system configured to receive orders from buyers via the Internet, and to selectively distribute those orders to a network of growers via the Internet. As can be appreciated, other communications networks or links can be utilized.

The exemplary embodiment of the system includes a software portion installed and executable by a system server connected to the Internet. The system is configured to communicate with consumers and growers operating remote terminals connected to the Internet. A system administrator may also access the system via a remote terminal connected to the Internet or via a terminal connected to the system server through another communications path. Typically, the system is configured to provide a distinct interface for communications with each type of user including a consumer, grower, and administrator.

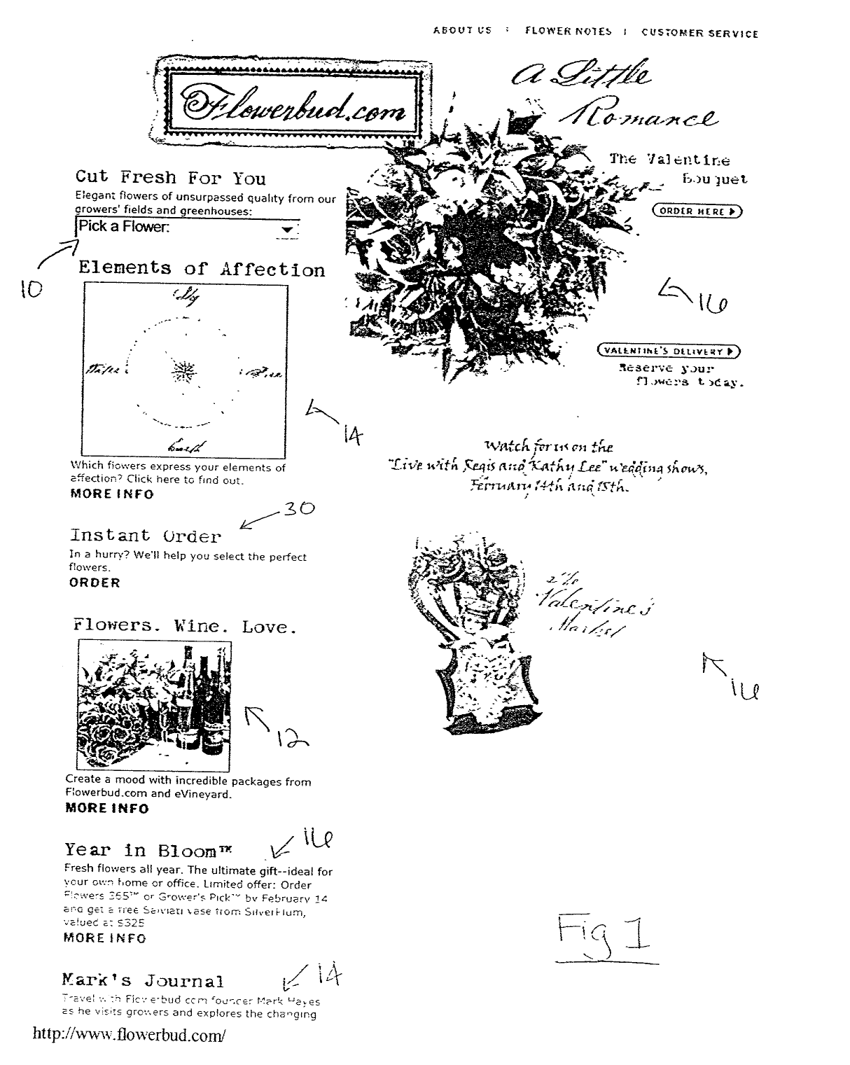

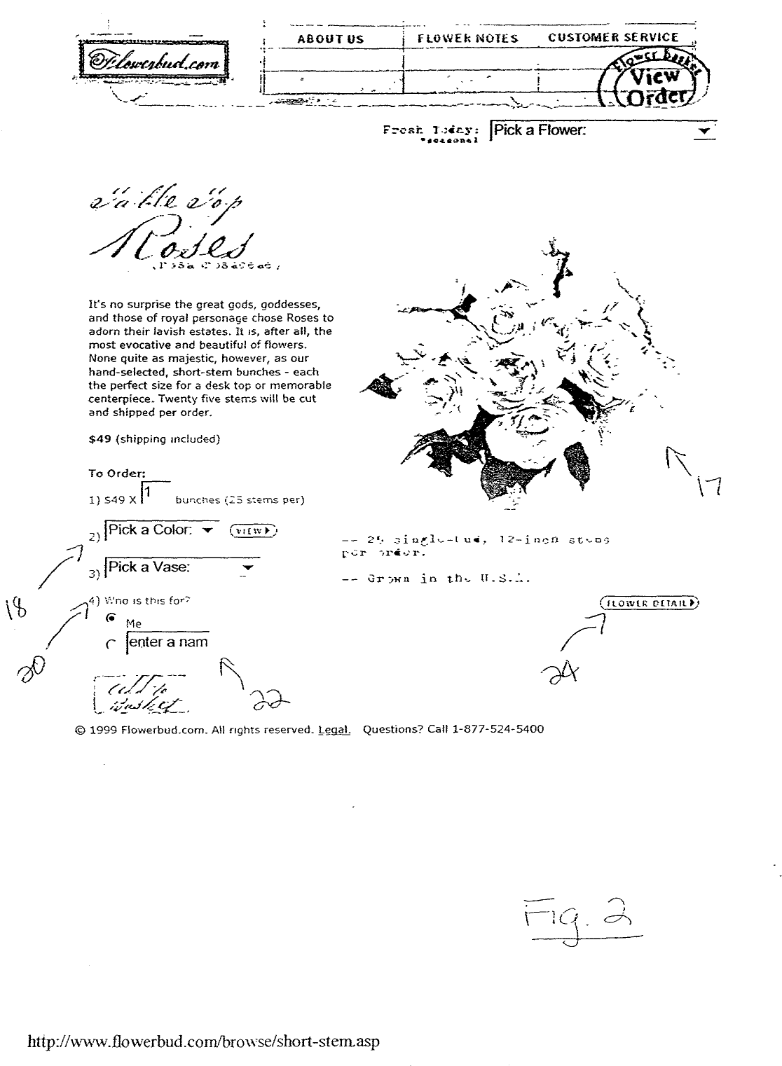

The user interface provided by the exemplary system may include any one or a combination of a variety of features for selecting and purchasing agricultural products. As illustrated in an embodiment described with reference to FIGS. 1-8, a consumer interface of an exemplary implementation of the system and method configured to process orders and distribution of flowers via the Internet.

Referring to FIG. 1, an exemplary Internet home World Wide Web page is shown. A customer may begin a flower shopping transaction at such a page. The web page includes a pull-down menu of flowers 10 by which a consumer may review the flowers available for purchase. The home page may also include hypertext links to other consumer resources such as related products available for purchase 12, general information on flowers 14, special offers and advertisements 16, for example.

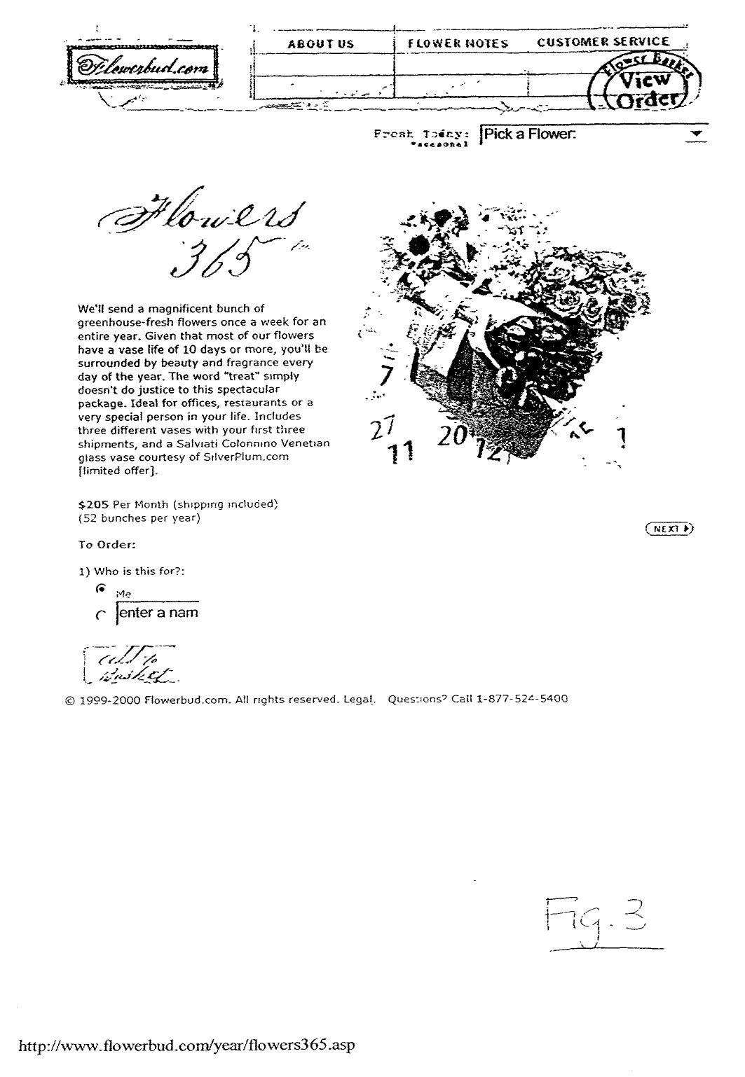

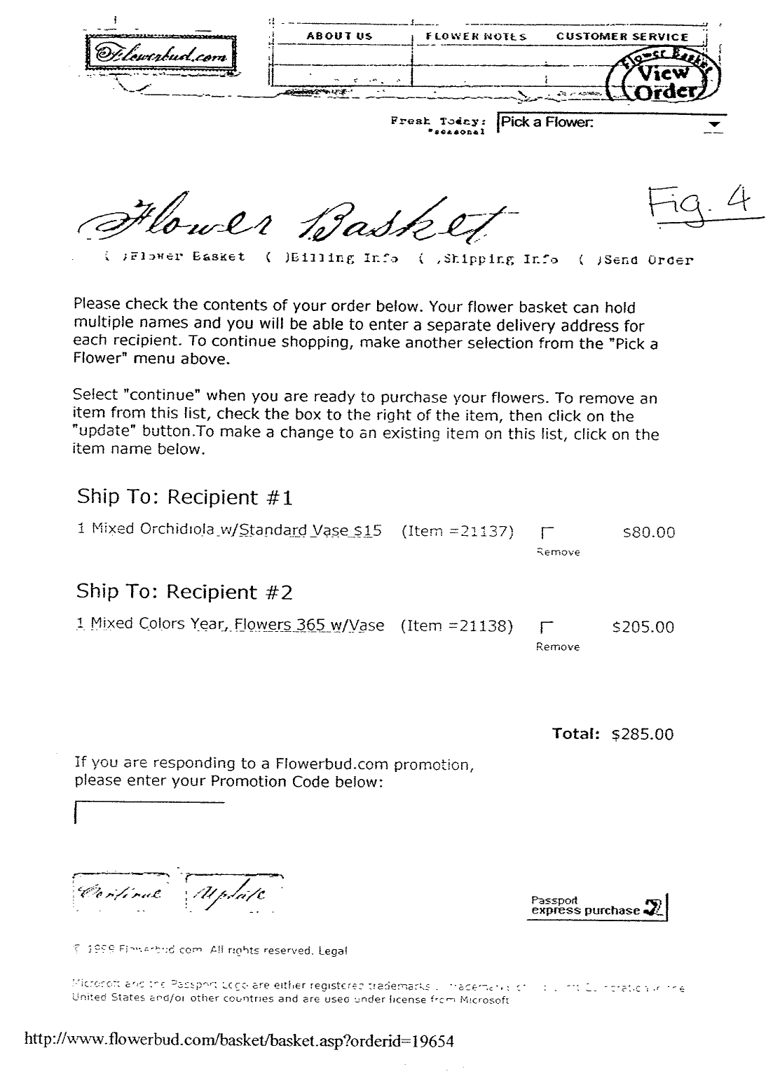

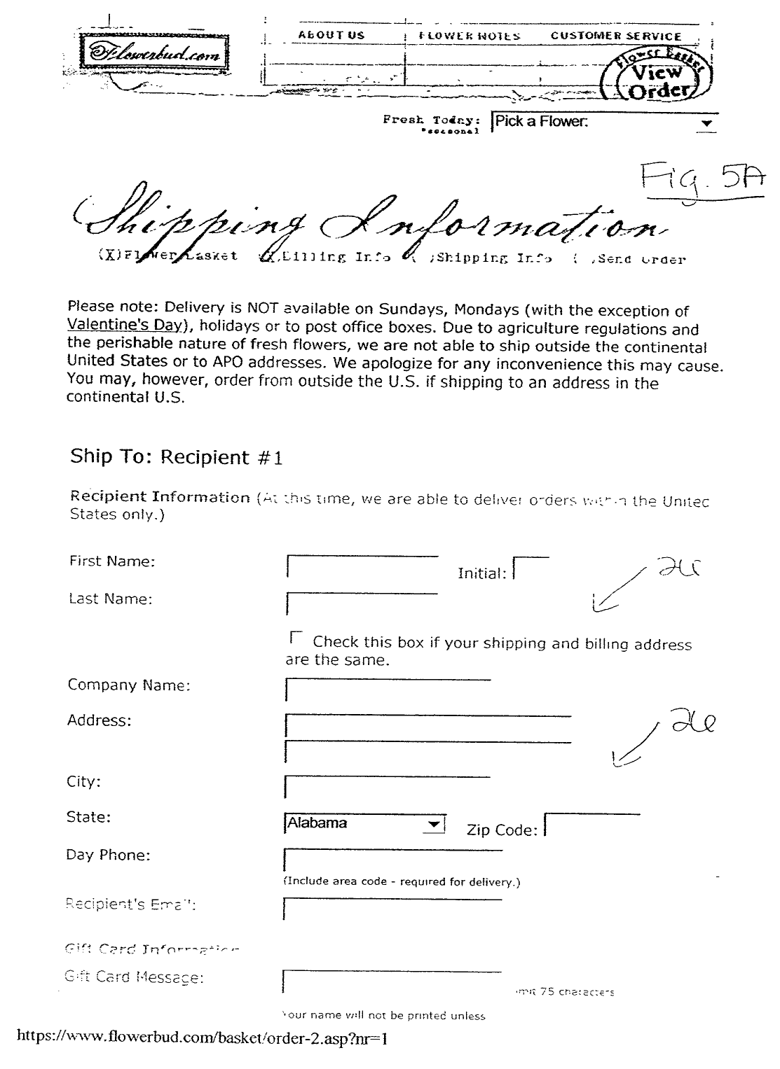

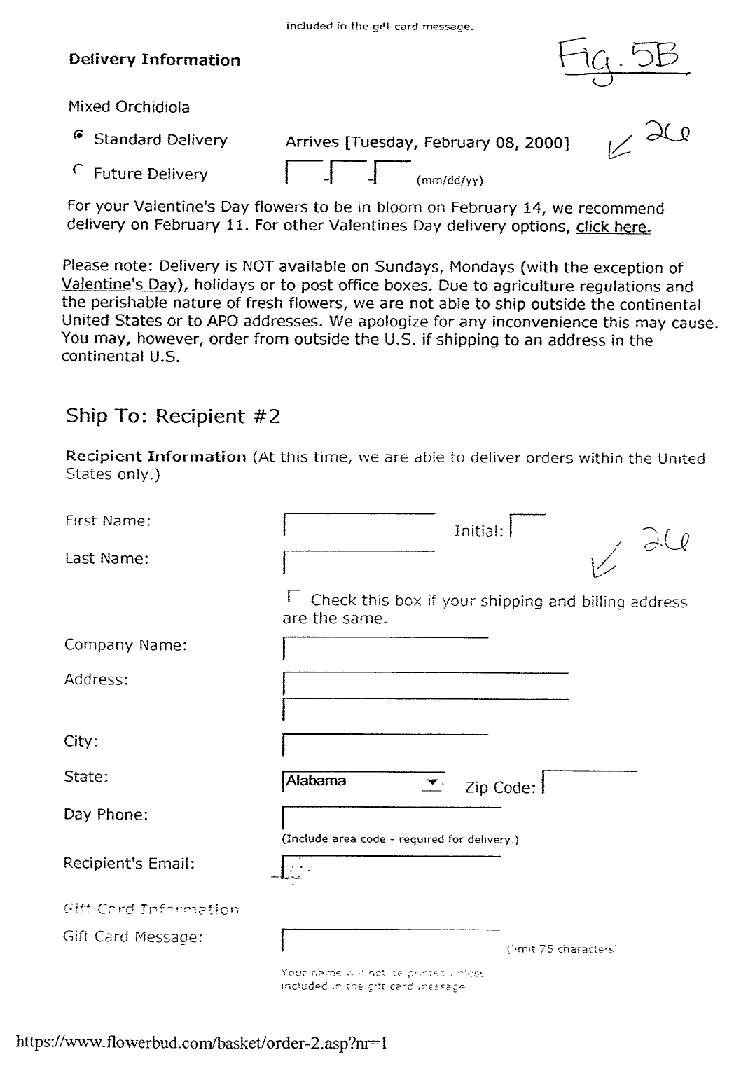

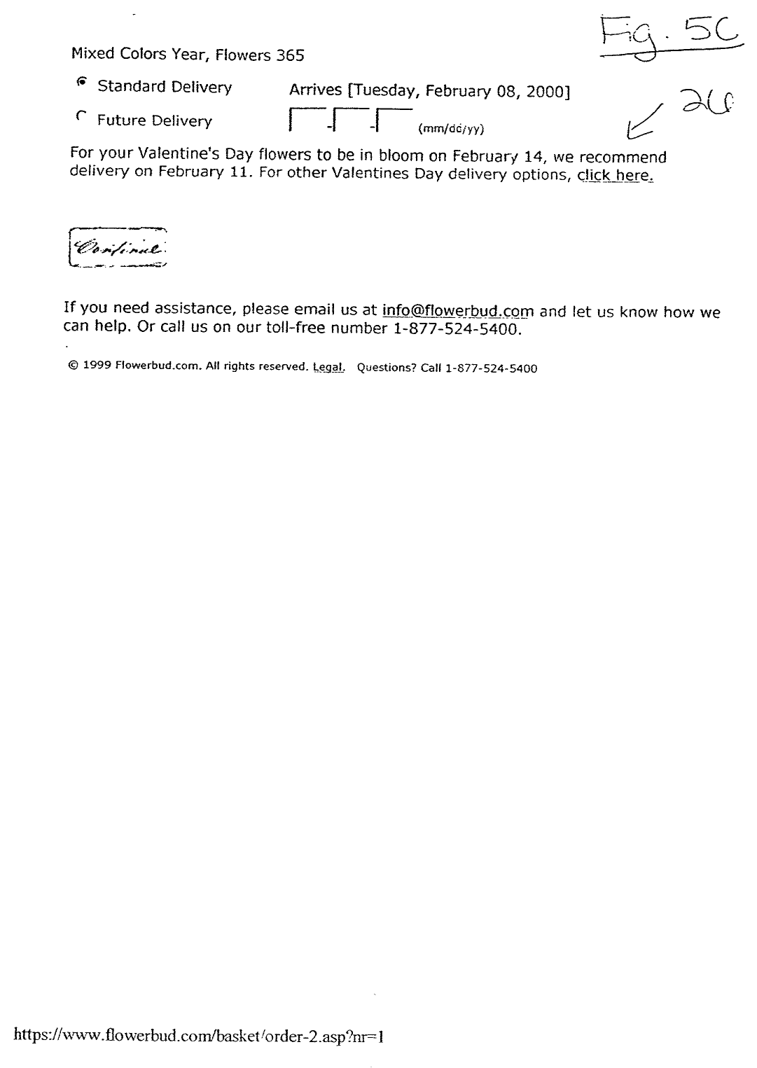

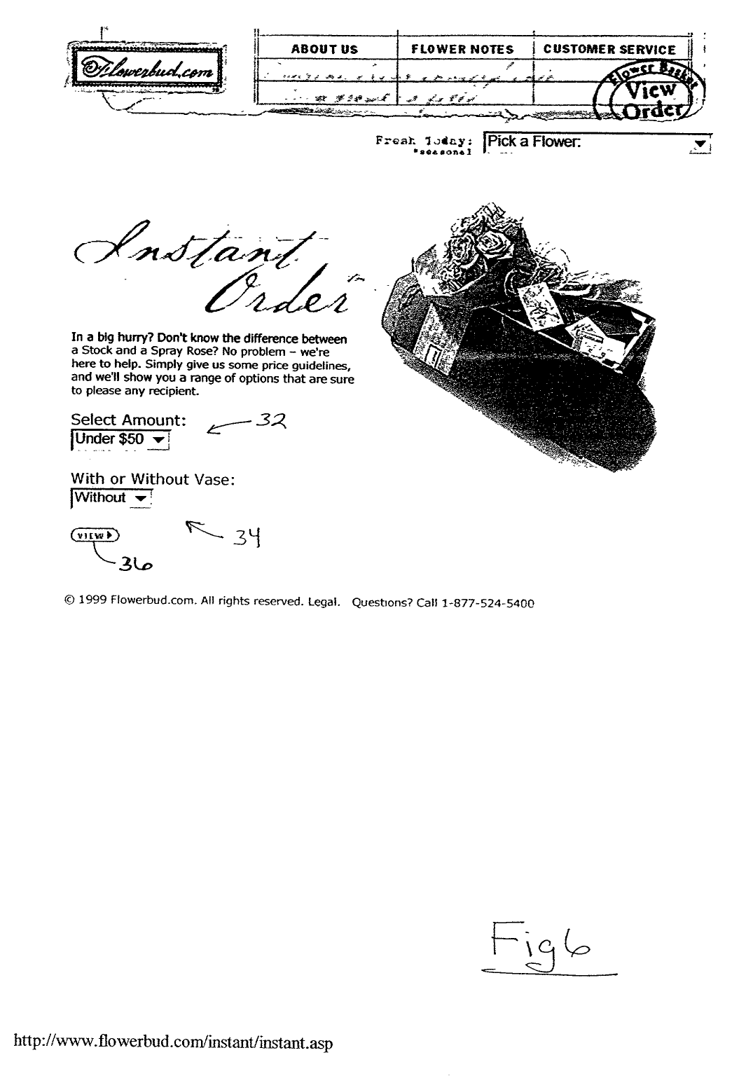

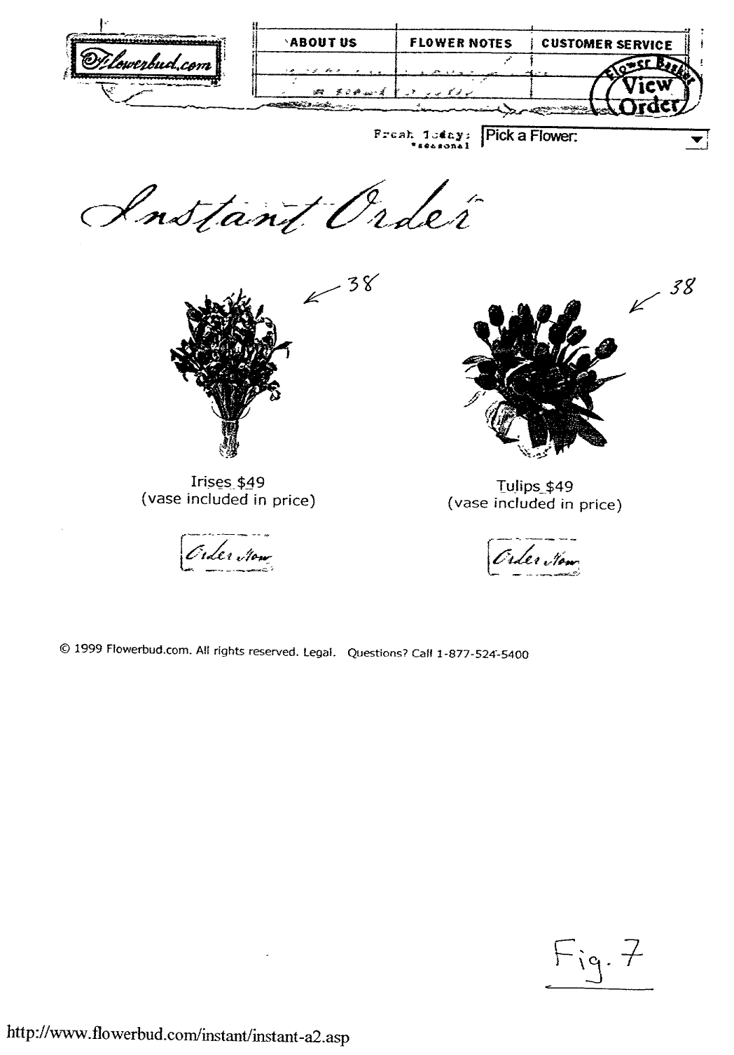

Using the interface, a consumer may shop for a particular flower by selecting it from the pull-down menu. The system then responds with a web page specific to the selected flower, as shown in FIG. 2. The specific flower web page includes general information specific to the selected flower, as well as an image 17 of the flower. A pull-down menu 18 may be provided to allow the consumer to select a particular feature of the flower such as color, for example. Once the consumer selects the desired feature(s), image 17 may be updated to show a flower with the selected features. Typically, another pull-down menu 20 may be provided to allow the consumer to select from a list of available vases or to select not to purchase a vase. One or more data entry fields 22 may be provided to allow the consumer to specify the recipient of the flowers purchased. A details link 24 provides the consumer with additional information about the selected flower.

In addition to allowing the consumer to place a single order for flowers, FIG. 3 illustrates an exemplary web page from which the consumer may order flowers for automatic delivery on a periodic basis such as once per week, month, etc. The system is configured to store the order and automatically repeat execution of the order on the selected periodic basis as a subscription.

According to one embodiment of the invention, a consumer may make multiple purchases during a single shopping transaction and have the purchases sent to multiple locations. This embodiment is illustrated in FIG. 4, which shows the consumer's “flower basket” containing the flowers selected for purchase and indicating shipment to multiple recipients. Once the consumer confirms the selections, the system responds with a shipping web page illustrated in FIGS. 5A-5C. The consumer may specify where the flowers should be delivered by entering the appropriate information into the data entry fields 26 on the shipping web page. The consumer may also specify whether the flowers should be delivered immediately or on some future date.

In another embodiment of the invention, the system is configured to suggest suitable purchases based on the consumer's inputs. For example, the exemplary home page depicted in FIG. 1 includes a consumer-selectable hyper-text link 30 which initiates an expedited purchasing process such as the “Instant Order” feature of the exemplary embodiment. The Instant Order feature provides purchase suggestions which a consumer may consider for quick purchases. When the consumer selects link 30, the system responds with the Instant Order query web page illustrated in FIG. 6. The Instant Order query web page includes one or more consumer-selectable criteria which enable the system to make purchase suggestions tailored to the consumer's needs. For example, the Instant Order query web page illustrated in FIG. 6 includes a purchase cost amount selector 32 and a vase selector 34. It will be appreciated that many other criteria may be used instead of, or in addition to, the above criteria, such as date of delivery, geographic region of delivery, color preference, size, occasion, relationship of recipient to consumer, etc. After making the desired selections, the consumer selects a “view” link 36 to request suggestions corresponding to the selected criteria.

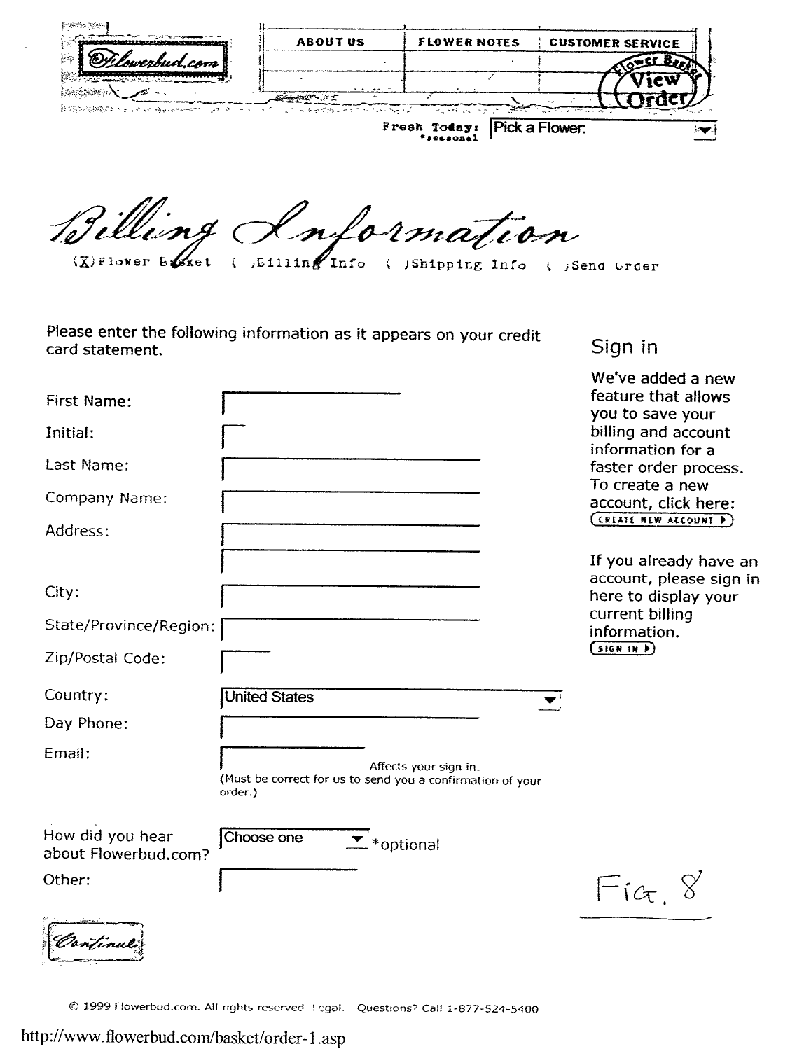

The exemplary system then responds with an Instant Order Suggestions web page such as illustrated in FIG. 7. The Instant Order Suggestions web page includes one or more selections of flowers 38 which meet the criteria selected by the consumer. The consumer may accept one of the purchase suggestions by selecting the associated hypertext link. The system responds with a billing information web page, such as illustrated in FIG. 8, followed by a shipping information web page such as illustrated in FIGS. 5A-5C. Thus, the Instant Order feature of the exemplary embodiment allows a consumer to identify a suitable purchase without browsing through the various lists of flowers and other products offered for purchase.

Typically the consumer completes a purchase transaction by entering appropriate payment authorization. The system then executes the order by automatically transmitting it to one or more of multiple flower growers depending on a variety of factors. Upon receipt of the order, the growers package the selected flowers and ship them to the recipients specified by the consumer. However, the flowers are shipped under a single label associated with the ordering system so that the network of independent growers appear as a single, reliable source to the consumer. By linking the independent growers under a single brand in a way that is transparent to the consumers, the growers can realize the benefit of combined brand loyalty and recognition based on sales of multiple growers across a region. In addition, the system can provide consumers with a single source which is capable of supplying fresh flowers of such diversity and quantity as would be virtually impossible for a single grower.

It will be appreciated that there are a variety of ways in which the system may be configured to distribute and allocate consumer order to the network of growers. In one exemplary embodiment, the administrator interface is configured to allow the system administrator to manage the flow of orders from a remote terminal. The system, orders and administrative information is stored on a database which also is managed through the administrator interface.

Through the interface, the administrator enters products (e.g., roses, tulips, bouquets, etc.), then for each product the administrator selects a distributor/grower, a priority for that grower, a daily maximum quantity, a percentage of the product that goes to the grower and a percentage that applies to the daily maximum. Once product sales reach the number that is the percentage of the daily quota, the system communicates a message to the administrator. Orders are associated with a specific grower based on information entered by the administrator. If there is only one grower in the network for a particular product, then all orders for the product will be sent to that grower. If there is more than one grower, orders are distributed based on the percent distribution associated with the product and grower. Alternatively, if the daily quota is met with the priority 1 grower, orders are then sent to the priority 2 grower.

Once products are in the database and associated with a specific grower the administrator may change the grower in one of several ways. For example, the administrator can redirect orders that have not been received. In effect, this is a one-day change to the priority of the grower.

For example, if on a particular day grower A does not have orange lilies, the administrator can direct orders for orange lilies to grower B. On the next day, the new orders will revert to grower A (in order to make a longer-term change, the administrator changes the grower's priority).

After an order is received but before a grower prints shipping information, the administrator can cancel the order to that grower and redirect orders to alternate growers on that product list. After the label has been printed, the label can be voided and the administrator can then redirect the order to an alternate grower.

In addition, the administrator interface allows the administrator to find and change most customer-input information about an order, i.e. shipping date and address, actual item, gift message, etc.

As mentioned above, the grower interface is also accessible through the system server via the Internet.

Growers access their specific order and quota information by entering a user name and password. Then they can access new orders. They have a list of all orders for the current day and for future days, allowing the growers to plan their shipments in advance. The grower interface also provides a shipping label generation function allowing the growers to automatically print shipping labels for each consumer order. The system also allows the grower to print out the gift card (if any) specified by the consumer for inclusion in the shipment. Each individual order is printed out on a single form including shipping tracking codes, etc. For example, the shipping label may be a UPS approved label generated by the system interfaced with Aristo software. The tracking numbers are assigned by the system and then sent to UPS electronically when a grower closes the day.

After the grower has packed the orders and knows they can fill them all, they access the system via the interface to close the day. If they could not fill an order, the interface allows them to void an order, in which case the order is returned to the administrator to be redirected to another grower.

Through the grower interface the growers can also request a change in their daily quotas, request supplies and review the grower administration/instruction manual.

Although the present invention has been described in relation to particular preferred embodiments thereof, many variations and modifications and other uses may be made without departing from the invention. Accordingly, it is intended that all such alterations and modifications be included within the spirit and scope of the invention as defined in the appended claims.

We claim:

1. A method of distributing agricultural products utilizing a system server having a database and communications network interface comprising:
providing indicia of available agricultural products selected from the system server database to a consumer user terminal utilizing a communications network;
receiving an indication of at least one ordered agricultural product from the user terminal utilizing the communications network;
providing order fulfillment information from the system server to the at least one distributor according to distributor priority for at least one of the at least one ordered agricultural product; and
receiving an indicia of distributor order fulfillment

2. The method of claim 1 further comprising:
receiving input indicia of available agricultural products into the system server database;
receiving input distributor information into the system server database;
receiving input distributor selection information into the system server database including a priority and maximum quota for at least one available agricultural product;
receiving an indication of payment information from a user consumer terminal utilizing the communications network;
receiving an indication of shipping information from a user consumer terminal utilizing the communications network; and
selecting at least one distributor for order fulfillment based upon the distributor selection information,
wherein
the order fulfillment information comprises information formatted for printing a single form including a shipping label, order fulfillment sheet and consumer message.

3. The method of claim 2, wherein
the distributor priority is modified due to received indicia of distributor order fulfillment.

4. The method of claim 2 further comprising:
wherein the order fulfillment information is provided to the at least one distributor utilizing the communications network and further comprising
receiving distributor identification and authentication information
confirming distributor authenticity; and
providing order fulfillment information to a distributor terminal utilizing the communications network.

5. The method of claim 2 further comprising:
redirecting unfulfilled orders to another distributor.

6. The method of claim 2, wherein
order fulfillment utilizes a common brand.

7. The method of claim 2, wherein
the system server comprises a geographically balanced server system utilizing order indicia geographically coded to ensure unique system-wide order indicia

8. The method of claim 2, wherein
the communications network comprises the Internet.

9. The method of claim 1, wherein
providing indicia of available agricultural products from a system server to the consumer user terminal utilizing a communications network comprises one or more consumer selectable criteria; and further comprising,
receiving at least one indicia representing a consumer selection of a consumer selectable criteria; and
providing indicia of available agricultural products from a system server to a user terminal consistent with the at least one selected consumer selectable criteria.

10. The method of claim 1, wherein
receiving the indication of at least one ordered agricultural product comprises an order for a subscription to an agricultural product order.

11. The method of claim 10, wherein
the subscription comprises a designated order category that includes differing agricultural products consistent with the category.

12. The method of claim 11, wherein
the subscription comprises differing agricultural products according to seasonal availability.

13. An agricultural product distribution system comprising:
a system server having a data processor connected to a client using a communications network;
a storage device connected to the data processor;
the storage device storing a system server database;
the storage device storing a logic program; and
the data processor operative with the logic program to perform:
receiving input indicia of available agricultural products into the system server database;
receiving input of distributor information into the system server database;
receiving input of distributor selection information into the system server database including a priority and maximum quota for at least one available agricultural product;
providing indicia of available agricultural products selected from the system server database to a consumer user terminal utilizing the communications network;
receiving an indication of at least one ordered agricultural product from the user terminal utilizing the communications network;
selecting at least one distributor for order fulfillment based upon the distributor selection information;
providing origin and destination shipping information from the system server to at least one shipping company;
providing order fulfillment information from the system server to the at least one selected distributor for at least one of the at least one ordered agricultural product, wherein the order fulfillment information comprises information formatted for printing a single form including a shipping label, order fulfillment sheet and consumer message;
receiving an indication of payment information from a user consumer terminal utilizing the communications network;
receiving an indication of shipping information from a user consumer terminal utilizing the communications network; and
receiving an indicia of distributor order fulfillment.

14. An article of manufacture comprising:
a computer readable medium having a computer readable program code embodied therein, the computer readable program code means including:
means for receiving input indicia of available agricultural products into the system server database;
means for receiving input of distributor information into the system server database;
means for receiving input of distributor selection information into the system server database including a priority and maximum quota for at least one available agricultural product;
means for providing indicia of available agricultural products selected from the system server database to a consumer user terminal utilizing the communications network;
means for receiving an indication of at least one ordered agricultural product from the user terminal utilizing the communications network;
means for selecting at least one distributor for order fulfillment based upon the distributor selection information;
means for providing order fulfillment information from the system server to the at least one selected distributor for at least one of the at least one ordered agricultural product, wherein the order fulfillment information comprises information formatted for printing a single form including a shipping label, order fulfillment sheet and consumer message;
means for receiving an indication of payment information from a user consumer terminal utilizing the communications network;
means for receiving an indication of shipping information from a user consumer terminal utilizing the communications network; and
means for receiving an indicia of distributor order fulfillment.
